(19) United States
(12) Patent Application Publication
(10) Pub. No.: US 2008/0066147 A1
(43) Pub. Date: Mar. 13, 2008

(54) Composable Security Policies

(75) Inventors: Blair B. Dillaway, Redmond, WA (US); Brian A. LaMacchia, Bellevue, WA (US); Gregory D. Fee, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/530,543

(22) Filed: Sep. 11, 2006

(51) Int. Cl. G06F 17/00

(52) U.S. Cl. 726/1

(57) ABSTRACT

Composable security policies enable multiple authorization policies to be combined into a composed effective authorization policy such that policy authoring rights may be arbitrarily and flexibly delegated. In an example implementation, making an authorization decision based on a composed effective policy is described. In another example implementation, the delegation of policy authoring rights using an assertion in accordance with a security language is described. In yet another example implementation, a security authorization system is described that includes a mechanism enabling an administrator to explicitly grant all or a part of policy authoring rights to another administrator.

### BACKGROUND

Computers and other electronic devices are pervasive in the professional and personal lives of people. In professional settings, people exchange and share confidential information during project collaborations. In personal settings, people engage in electronic commerce and the transmission of private information. In these and many other instances, electronic security is deemed to be important.

Electronic security paradigms can keep professional information confidential and personal information private. Electronic security paradigms may involve some level of encryption and/or protection against malware, such as viruses, worms, and spyware. Both encryption of information and protection from malware have historically received significant attention, especially in the last few years.

However, controlling access to information is an equally important aspect of securing the safety of electronic information. This is particularly true for scenarios in which benefits are derived from the sharing and/or transferring of electronic information. In such scenarios, certain people are to be granted access while others are to be excluded.

Access control has been a common feature of shared computers and application servers since the early time-shared systems. There are a number of different approaches that have been used to control access to information. They share a common foundation in combining authentication of the entity requesting access to some resource with a mechanism of authorizing the allowed access. Authentication mechanisms include passwords, Kerberos, and X.509 certificates. Their purpose is to allow a resource-controlling entity to positively identify the requesting entity or information about the entity that it requires.

Authorization examples include access control lists (ACLs) and policy-based mechanisms such as the eXtensible Access Control Markup Language (XACML) or the PrivilEge and Role Management Infrastructure (PERMIS). These mechanisms define what entities may access a given resource, such as files in a file system, hardware devices, database information, and so forth. They perform this authorization by providing a mapping between authenticated information about a requestor and the allowed access to a resource.

As computer systems have become more universally connected over large networks such as the Internet, these mechanisms have proven to be somewhat limited and inflexible in dealing with evolving access control requirements. Systems of geographically dispersed users and computer resources, including those that span multiple administrative domains, in particular present a number of challenges that are poorly addressed by currently-deployed technology.

### SUMMARY

Composable security policies enable multiple authorization policies to be combined into a composed effective authorization policy such that policy authoring rights may be arbitrarily and flexibly delegated. In an example implementation, making an authorization decision based on a composed effective policy is described. In another example implementation, the delegation of policy authoring rights using an assertion in accordance with a security language is described. In yet another example implementation, a security authorization system is described that includes a mechanism enabling an administrator to explicitly grant all or a part of policy authoring rights to another administrator.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other method, system, scheme, apparatus, device, media, procedure, API, arrangement, protocol, etc. implementations are described herein.

### BRIEF DESCRIPTION OF THE DRAWINGS

The same numbers are used throughout the drawings to reference like and/or corresponding aspects, features, and components.

FIG. 1 is a block diagram illustrating an example general environment in which an example security scheme may be implemented.

FIG. 2 is a block diagram illustrating an example security environment having two devices and a number of example security-related components.

FIG. 3 is a block diagram illustrating the example security environment of FIG. 2 in which example security-related data is exchanged among the security-related components.

FIG. 4 is a block diagram of an example device that may be used for security-related implementations as described herein.

FIG. 5 is a block diagram illustrating an example assertion format for a general security scheme.

FIG. 6 is a block diagram illustrating an example security authorization system in which multiple authorization policies may be combined into a composed effective authorization policy.

FIG. 7 is a block diagram illustrating an example of horizontal delegation of policy authoring rights.

FIG. 8 is a block diagram illustrating an example of hierarchical delegation of policy authoring rights.

FIG. 9 is a block diagram illustrating example categories of policy authoring rights on a resource.

FIG. 10 is a flow diagram illustrating an example of a method for delegating portions of policy authoring rights.

FIG. 11 is a flow diagram illustrating an example of a method for making authorization decisions based on a composed effective policy.

### DETAILED DESCRIPTION

### Example Security Environments

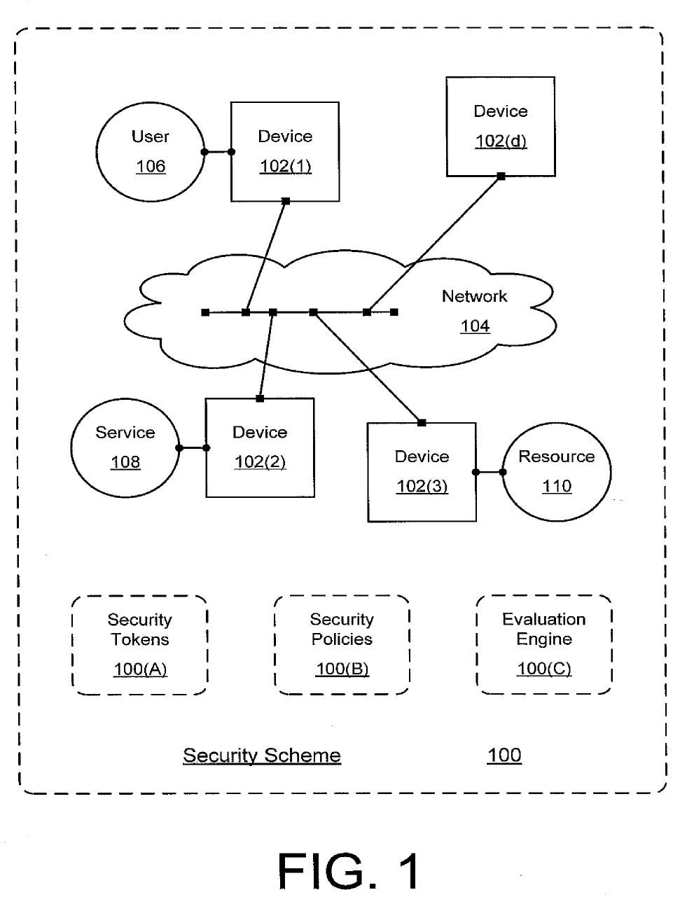

FIG. 1 is a block diagram illustrating an example general environment in which an example security scheme 100 may be implemented. Security scheme 100 represents an integrated approach to security. As illustrated, security scheme 100 includes a number of security concepts: security tokens 100(A), security policies 100(B), and an evaluation engine 100(C). Generally, security tokens 100(A) and security policies 100(B) jointly provide inputs to evaluation engine 100(C). Evaluation engine 100(C) accepts the inputs and produces an authorization output that indicates if access to some resource should be permitted or denied.

In a described implementation, security scheme 100 can be overlaid and/or integrated with one or more devices 102, which can be comprised of hardware, software, firmware, some combination thereof, and so forth. As illustrated, “d” devices, with “d” being some integer, are interconnected over one or more networks 104. More specifically, device 102(1), device 102(2), device 102(3) . . . device 102(d) are capable of communicating over network 104.

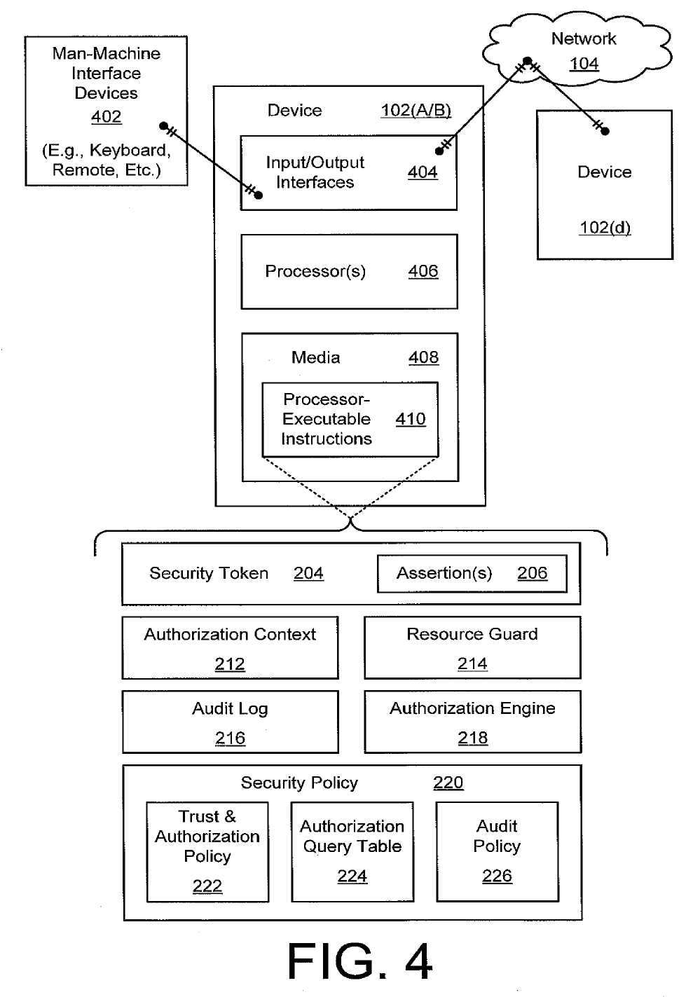

Each device 102 may be any device that is capable of implementing at least a part of security scheme 100. Examples of such devices include, but are not limited to, computers (e.g., a client computer, a server computer, a personal computer, a workstation, a desktop, a laptop, a palm-top, etc.), game machines (e.g., a console, a portable game device, etc.), set-top boxes, televisions, consumer electronics (e.g., DVD player/recorders, camcorders, digital video recorders (DVRs), etc.), personal digital assistants (PDAs), mobile phones, portable media players, some combination thereof, and so forth. An example electronic device is described herein below with particular reference to FIG. 4.

Network 104 may be formed from any one or more networks that are linked together and/or overlaid on top of each other. Examples of networks 104 include, but are not limited to, an internet, a telephone network, an Ethernet, a local area network (LAN), a wide area network (WAN), a cable network, a fibre network, a digital subscriber line (DSL) network, a cellular network, a Wi-Fi® network a WiMAX® network, a virtual private network (VPN), some combination thereof, and so forth. Network 104 may include multiple domains, one or more grid networks, and so forth. Each of these networks or combination of networks may be operating in accordance with any networking standard.

As illustrated, device 102(1) corresponds to a user 106 that is interacting with it. Device 102(2) corresponds to a service 108 that is executing on it. Device 102(3) is associated with a resource 110. Resource 110 may be part of device 102(3) or separate from device 102(3).

User 106, service 108, and a machine such as any given device 102 form a non-exhaustive list of example entities. Entities, from time to time, may wish to access resource 110. Security scheme 100 ensures that entities that are properly authenticated and authorized are permitted to access resource 110 while other entities are prevented from accessing resource 110.

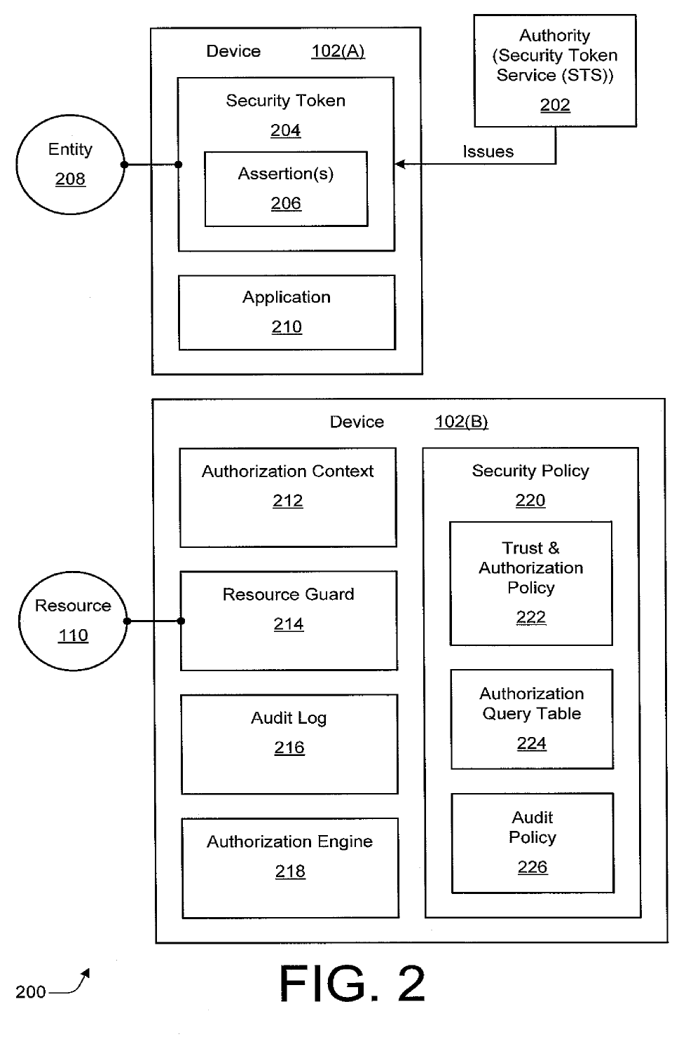

FIG. 2 is a block diagram illustrating an example security environment 200 having two devices 102(A) and 102(B) and a number of example security-related components. Security environment 200 also includes an authority 202, such as a security token service (STS) authority. Device 102(A) corresponds to an entity 208. Device 102(B) is associated with resource 110. Although a security scheme 100 may be implemented in more complex environments, this relatively-simple two-device security environment 200 is used to describe example security-related components.

As illustrated, device 102(A) includes two security-related components: a security token 204 and an application 210. Security token 204 includes one or more assertions 206. Device 102(B) includes five security-related components: an authorization context 212, a resource guard 214, an audit log 216, an authorization engine 218, and a security policy 220. Security policy 220 includes a trust and authorization policy 222, an authorization query table 224, and an audit policy 226.

Each device 102 may be configured differently and still be capable of implementing all or a part of security scheme 100. For example, device 102(A) may have multiple security tokens 204 and/or applications 210. As another example, device 102(B) may not include an audit log 216 or an audit policy 226. Other configurations are also possible.

In a described implementation, authority 202 issues security token 204 having assertions 206 to entity 208. Assertions 206 are described herein below, including in the section entitled “Security Policy Assertion Language Example Characteristics”. Entity 208 is therefore associated with security token 204. In operation, entity 208 wishes to use application 210 to access resource 110 by virtue of security token 204.

Resource guard 214 receives requests to access resource 10 and effectively manages the authentication and authorization process with the other security-related components of device 102(B). Trust and authorization policy 222, as its name implies, includes policies directed to trusting entities and authorizing actions within security environment 200. Trust and authorization policy 222 may include, for example, security policy assertions (not explicitly shown in FIG. 2). Authorization query table 224 maps requested actions, such as access requests, to an appropriate authorization query. Audit policy 226 delineates audit responsibilities and audit tasks related to implementing security scheme 100 in security environment 200.

Authorization context 212 collects assertions 206 from security token 204, which is/are used to authenticate the requesting entity, and security policy assertions from trust and authorization policy 222. These collected assertions in authorization context 212 form an assertion context. Hence, authorization context 212 may include other information in addition to the various assertions.

The assertion context from authorization context 212 and an authorization query from authorization query table 224 are provided to authorization engine 218. Using the assertion context and the authorization query, authorization engine 218 makes an authorization decision. Resource guard 214 responds to the access request based on the authorization decision. Audit log 216 contains audit information such as, for example, identification of the requested resource 110 and/or the algorithmic evaluation logic performed by authorization engine 218.

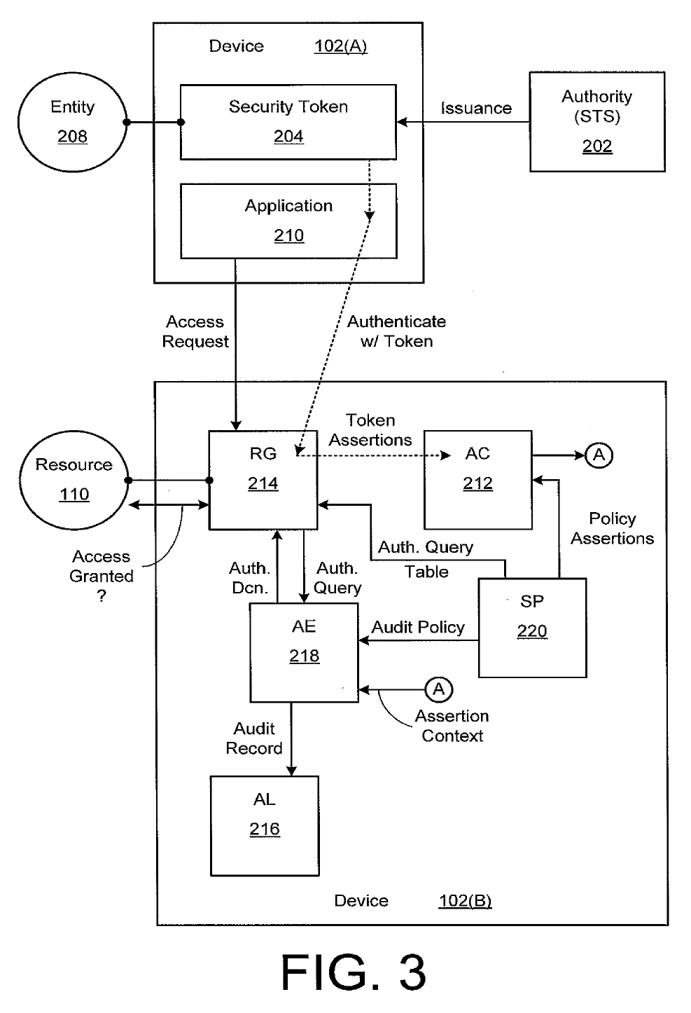

FIG. 3 is a block diagram illustrating example security environment 200 in which example security-related data is exchanged among the security-related components. The security-related data is exchanged in support of an example access request operation. In this example access request operation, entity 208 wishes to access resource 110 using application 210 and indicates its authorization to do so with security token 204. Hence, application 210 sends an access request* to resource guard 214. In this description of FIG. 3, an asterisk (i.e., “*”) indicates that the stated security-related data is explicitly indicated in FIG. 3.

In a described implementation, entity 208 authenticates* itself to resource guard 214 with a token*, security token 204. Resource guard 214 forwards the token assertions* to authorization context 212. These token assertions are assertions 206 (of FIG. 2) of security token 204. Security policy 220 provides the authorization query table* to resource guard 214. The authorization query table derives from authorization query table module 224. The authorization query table sent to resource guard 214 may be confined to the portion or portions directly related to the current access request.

Policy assertions are extracted from trust and authorization policy 222 by security policy 220. The policy assertions may include both trust-related assertions and authorization-related assertions. Security policy 220 forwards the policy assertions* to authorization context 212. Authorization context 212 combines the token assertions and the policy assertions into an assertion context. The assertion context* is provided from authorization context 212 to authorization engine 218 as indicated by the encircled “A”.

An authorization query is ascertained from the authorization query table. Resource guard 214 provides the authorization query (auth. query*) to authorization engine 218. Authorization engine 218 uses the authorization query and the assertion context in an evaluation algorithm to produce an authorization decision. The authorization decision (auth. dcn.*) is returned to resource guard 214. Whether entity 208 is granted access* to resource 110 by resource guard 214 is dependent on the authorization decision. If the authorization decision is affirmative, then access is granted. If, on the other hand, the authorization decision issued by authorization engine 218 is negative, then resource guard 214 does not grant entity 208 access to resource 110.

The authorization process can also be audited using semantics that are complementary to the authorization process. The auditing may entail monitoring of the authorization process and/or the storage of any intermediate and/or final products of, e.g., the evaluation algorithm logically performed by authorization engine 218. To that end, security policy 220 provides to authorization engine 218 an audit policy* from audit policy 226. At least when auditing is requested, an audit record* having audit information may be forwarded from authorization engine 218 to audit log 216. Alternatively, audit information may be routed to audit log 216 via resource guard 214, for example, as part of the authorization decision or separately.

FIG. 4 is a block diagram of an example device 102 that may be used for security-related implementations as described herein. Multiple devices 102 are capable of communicating across one or more networks 104. As illustrated, two devices 102(A/B) and 102(d) are capable of engaging in communication exchanges via network 104. Although two devices 102 are specifically shown, one or more than two devices 102 may be employed, depending on the implementation.

Generally, a device 102 may represent any computer or processing-capable device, such as a client or server device; a workstation or other general computer device; a PDA; a mobile phone; a gaming platform; an entertainment device; one of the devices listed above with reference to FIG. 1; some combination thereof; and so forth. As illustrated, device 102 includes one or more input/output (I/O) interfaces 404, at least one processor 406, and one or more media 408. Media 408 include processor-executable instructions 410.

In a described implementation of device 102, I/O interfaces 404 may include (i) a network interface for communicating across network 104, (ii) a display device interface for displaying information on a display screen, (iii) one or more man-machine interfaces, and so forth. Examples of (i) network interfaces include a network card, a modem, one or more ports, and so forth. Examples of (ii) display device interfaces include a graphics driver, a graphics card, a hardware or software driver for a screen or monitor, and so forth. Printing device interfaces may similarly be included as part of I/O interfaces 404. Examples of (iii) man-machine interfaces include those that communicate by wire or wirelessly to man-machine interface devices 402 (e.g., a keyboard, a remote, a mouse or other graphical pointing device, etc.).

Generally, processor 406 is capable of executing, performing, and/or otherwise effectuating processor-executable instructions, such as processor-executable instructions 410. Media 408 is comprised of one or more processor-accessible media. In other words, media 408 may include processor-executable instructions 410 that are executable by processor 406 to effectuate the performance of functions by device 102.

Thus, realizations for security-related implementations may be described in the general context of processor-executable instructions. Generally, processor-executable instructions include routines, programs, applications, coding, modules, protocols, objects, components, metadata and definitions thereof data structures, application programming interfaces (APIs), schema, etc. that perform and/or enable particular tasks and/or implement particular abstract data types. Processor-executable instructions may be located in separate storage media, executed by different processors, and/or propagated over or extant on various transmission media.

Processor(s) 406 may be implemented using any applicable processing-capable technology. Media 408 may be any available media that is included as part of and/or accessible by device 102. It includes volatile and non-volatile media, removable and non-removable media, and storage and transmission media (e.g., wireless or wired communication channels). For example, media 408 may include an array of disks/flash memory/optical media for longer-term mass storage of processor-executable instructions 410, random access memory (RAM) for shorter-term storing of instructions that are currently being executed, link(s) on network 104 for transmitting communications (e.g., security-related data), and so forth.

As specifically illustrated, media 408 comprises at least processor-executable instructions 410. Generally, processor-executable instructions 410, when executed by processor 406, enable device 102 to perform the various functions described herein, including those actions that are illustrated in the various flow diagrams. By way of example only, processor-executable instructions 410 may include a security token 204, at least one of its assertions 206, an authorization context module 212, a resource guard 214, an audit log 216, an authorization engine 218, a security policy 220 (e.g., a trust and authorization policy 222, an authorization query table 224, and/or an audit policy 226, etc.), some combination thereof, and so forth. Although not explicitly shown in FIG. 4, processor-executable instructions 410 may also include an application 210 and/or a resource 110.

### Security Policy Assertion Language Example Characteristics

This section describes example characteristics of an implementation of a security policy assertion language (SecPAL). The SecPAL implementation of this section is described in a relatively informal manner and by way of example only. It has an ability to address a wide spectrum of security policy and security token obligations involved in creating an end-to-end solution. These security policy and security token obligations include, by way of example but not limitation; describing explicit trust relationships; expressing security token issuance policies; providing security tokens containing identities, attributes, capabilities, and/or delegation policies; expressing resource authorization and delegation policies; and so forth.

In a described implementation, SecPAL is a declarative, logic-based language for expressing security in a flexible and tractable manner. It can be comprehensive, and it can provide a uniform mechanism for expressing trust relationships, authorization policies, delegation policies, identity and attribute assertions, capability assertions, revocations, audit requirements, and so forth. This uniformity provides tangible benefits in terms of making the security scheme understandable and analyzable. The uniform mechanism also improves security assurance by allowing one to avoid, or at least significantly curtail, the need for semantic translation and reconciliation between disparate security technologies.

A SecPAL implementation may include any of the following example features: [1] SecPAL can be relatively easy to understand. It may use a definitional syntax that allows its assertions to be read as English-language sentences. Also, its grammar may be restricted such that it requires users to understand only a few subject-verb-object (e.g., subject-verb phrase) constructs with cleanly defined semantics. Finally, the algorithm for evaluating the deducible facts based on a collection of assertions may rely on a small number of relatively simple rules.

[2] SecPAL can leverage industry standard infrastructure in its implementation to ease its adoption and integration into existing systems. For example, an extensible markup language (XML) syntax may be used that is a straightforward mapping from the formal model. This enables use of standard parsers and syntactic correctness validation tools. It also allows use of the W3C XML Digital Signature and Encryption standards for integrity, proof of origin, and confidentiality.

[3] SecPAL may enable distributed policy management by supporting distributed policy authoring and composition. This allows flexible adaptation to different operational models governing where policies, or portions of policies, are authored based on assigned administrative duties. Use of standard approaches to digitally signing and encrypting policy objects allow for their secure distribution. [4] SecPAL enables an efficient and safe evaluation. Simple syntactic checks on the inputs are sufficient to ensure evaluations will terminate and produce correct answers.

[5] SecPAL can provide a complete solution for access control requirements supporting required policies, authorization decisions, auditing, and a public-key infrastructure (PKI) for identity management. In contrast, most other approaches only manage to focus on and address one subset of the spectrum of security issues. [6] SecPAL may be sufficiently expressive for a number of purposes, including, but not limited to, handling the security issues for Grid environments and other types of distributed systems. Extensibility is enabled in ways that maintain the language semantics and evaluation properties while allowing adaptation to the needs of specific systems.

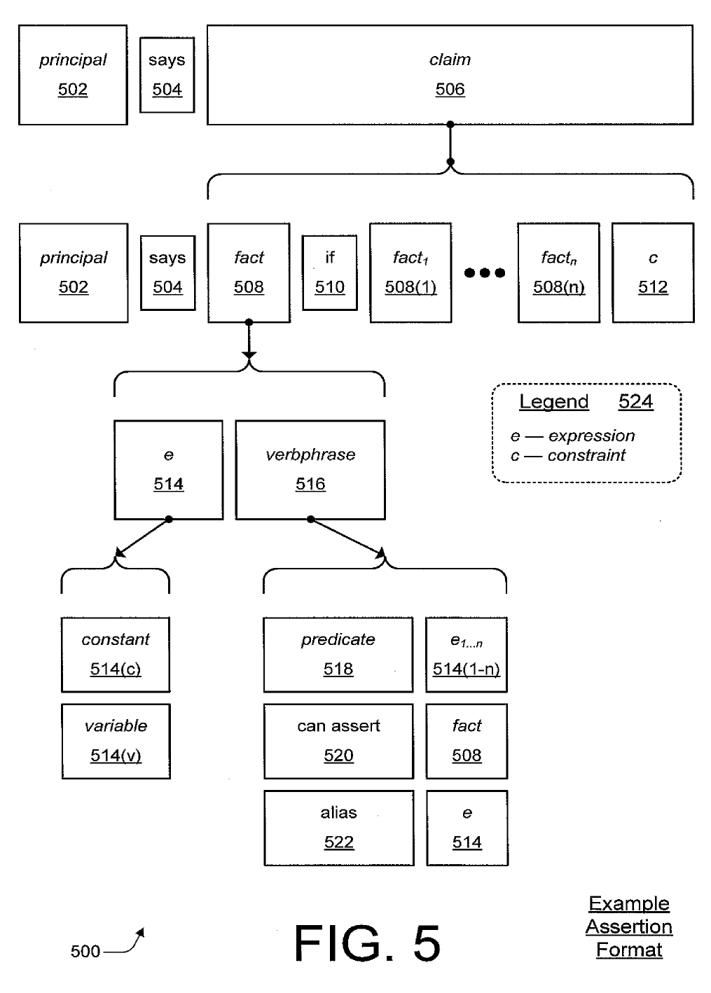

FIG. 5 is a block diagram illustrating an example assertion format 500 for a general security scheme. Security scheme assertions that are used in the implementations described otherwise herein may differ from example assertion format 500. However, assertion format 500 is a basic illustration of one example format for security scheme assertions, and it provides a basis for understanding example described implementation of various aspects of a general security scheme.

As illustrated at the top row of assertion format 500, an example assertion at a broad level includes: a principal portion 502, a says portion 504, and a claim portion 506. Textually, the broad level of assertion format 500 may be represented by: principal says claim.

At the next row of assertion format 500, claim portion 506 is separated into example constituent parts. Hence, an example claim portion 506 includes: a fact portion 508, an if portion 510, “n” conditional fact_{1 . . . n} portions 508(1 . . . n), and a c portion 512. The subscript “n” represents some integer value. As indicated by legend 524, c portion 512 represents a constraint portion. Although only a single constraint is illustrated, c portion 512 may actually represent multiple constraints (e.g., c₁, . . . ,cₘ). The set of conditional fact portions 508(1 . . . n) and constraints 512(1 . . . m) on the right-hand side of if portion 510 may be termed the antecedent.

Textually, claim portion 506 may be represented by: fact if fact₁, . . . , factₙ, c. Hence, the overall assertion format 500 may be represented textually as follows: principal says fact if fact₁, . . . , factₙ, c. However, an assertion may be as simple as: principal says fact. In his abbreviated, three-part version of an assertion, the conditional portion that starts with if portion 510 and extends to c portion 512 is omitted.

Each fact portion 508 may also be further subdivided into its constituent parts. Example constituent parts are: an e portion 514 and a verb phrase portion 516. As indicated by legend 524, e portion 514 represents an expression portion Textually, a fact portion 508 may be represented by: e verbphrase.

Each e or expression portion 514 may take on one of two example options. These two example expression options are: a constant 514(c) and a variable 514(v). Principals may fall under constants 514(c) and/or variables 514(v).

Each verb phrase portion 516 may also take on one of three example options. These three example verb phrase options are: a predicate portion 518 followed by one or more e_{1 . . . n} portions 514(1 . . . n), a can assert portion 520 followed by a fact portion 508, and an alias portion 522 followed by an expression portion 514. Textually, these three verb phrase options may be represented by: predicate e₁ . . . eₙ, can assert fact, and alias e, respectively. The integer “n” may take different values for facts 508(1 . . . n) and expressions 514(1 . . . n).

Generally, SecPAL statements are in the form of assertions made by a security principal. Security principals are typically identified by cryptographic keys so that they can be authenticated across system boundaries. In their simplest form, an assertion states that the principal believes a fact is valid (e.g., as represented by a claim 506 that includes a fact portion 508). They may also state a fact is valid if one or more other facts are valid and some set of conditions are satisfied (e.g., as represented by a claim 506 that extends from a fact portion 508 to an if portion 510 to conditional fact portions 508(1 . . . n) to a c portion 512). There may also be conditional facts 508(1 . . . n) without any constraints 512 and/or constraints 512 without any conditional facts 508(1 . . . n).

In a described implementation, facts are statements about a principal. Four example types of fact statements are described here in this section. First, a fact can state that a principal has the right to exercise an action(s) on a resource with an “action verb”. Example action verbs include, but are not limited to, call, send, read, list, execute, write, modify, append, delete, install, own, and so forth. Resources may be identified by universal resource indicators (URIs) or any other approach.

Second, a fact can express the binding between a principal identifier and one or more attribute(s) using the “possess” verb. Example attributes include, but are not limited to, email name, common name, group name, role title, account name, domain name server/service (DNS) name, internet protocol (IP) address, device name, application name, organization name, service name, account identification/identifier (ID), and so forth. An example third type of fact is that two principal identifiers can be defined to represent the same principal using the “alias” verb.

“Qualifiers” or fact qualifiers may be included as part of any of the above three fact types. Qualifiers enable an assertor to indicate environmental parameters (e.g., time, principal location, etc.) that it believes should hold if the fact is to be considered valid. Such statements may be cleanly separated between the assertor and a relying party's validity checks based on these qualifier values.

An example fourth type of fact is defined by the “can assert” verb. This “can assert” verb provides a flexible and powerful mechanism for expressing trust relationships and delegations. For example, it allows one principal (A) to state its willingness to believe certain types of facts asserted by a second principal (B). For instance, given the assertions “A says B can assert fact( )” and “B says fact( )”, it can be concluded that A believes fact( ) to be valid and therefore it can be deduced that “A says fact( )”.

Such trust and delegation assertions may be (i) unbounded and transitive to permit downstream delegation or (ii) bounded to preclude downstream delegation. Although qualifiers can be applied to “can assert” type facts, omitting support for qualifiers to these “can assert” type facts can significantly simplify the semantics and evaluation safety properties of a given security scheme.

In a described implementation, concrete facts can be stated, or policy expressions may be written using variables. The variables are typed and may either be unrestricted (e.g., allowed to match any concrete value of the correct type) or restricted (e.g., required to match a subset of concrete values based on a specified pattern).

Security authorization decisions are based on an evaluation algorithm (e.g., that may be conducted at authorization engine 218) of an authorization query against a collection of assertions (e.g., an assertion context) from applicable security policies (e.g., a security policy 220) and security tokens (e.g., one or more security tokens 204). Authorization queries are logical expressions, which may become quite complex, that combine facts and/or conditions. These logical expressions may include, for example, AND, OR, and/or NOT logical operations on facts, either with or without attendant conditions and/or constraints.

This approach to authorization queries provides a flexible mechanism for defining what must be known and valid before a given action is authorized. Query templates (e.g., from authorization query table 224) form a part of the overall security scheme and allow the appropriate authorization query to be declaratively stated for different types of access requests and other operations/actions.

### Example Implementations for Composable Security Policies

Especially in distributed computing systems, security management presents many challenges. It is better if adequate control and understanding of the security policies that are used in such a system are ensured while at the same time responsive and cost effective security management is provided. This creates a tension between centralized and de-centralized management approaches.

Centralized security management approaches can ensure consistent policies across an entire distributed system and provide a single point where all policies are visible. However, such centralized approaches are not generally very responsive as all changes must be processed by a single administrative team and then distributed outward to the enforcement points. De-centralized security management approaches, on the other hand, are typically very responsive with the local administrator for a machine or application able to make desired policy changes. Unfortunately, de-centralized approaches make it more difficult to understand the effective security policy for the entire system at any point in time.

Consequently, there is a need for a hybrid system that allows a degree of centralized control over the general security policy that the distributed system will enforce while still allowing local administrators to make adjustments to local machine and application policies. Existing systems fail to provide a general approach to addressing this administrative need.

Most systems provide little beyond a functional separation based on a set of disjoint policies. With most existing systems, there are distinct security policies for functions such as: trusted external authorities, file system authorization, application function authorization, network channel security, and so forth. Each of these distinct security policies can be configured independently with control limited by who can access the policy data. Tools do exist to allow a centralized administrative team to set these distinct security policies for an entire organization, with some policy being left to local control. However, the granularity of control is inherently limited by functional divisions determined at the time the system and applications were implemented.

There are a few systems that have been designed with hierarchical security policy control as a primary requirement. In one existing system, there are separate enterprise, machine, and user security policies with each of these constrained by the preceding policy or policies. This hierarchical approach is closer to what is needed, but it is still limited in several important ways. First, the hierarchical precedence is built into the system logic and cannot be overridden or altered. Second, the implementation is specific to one particular policy requirement. Third, policy authoring is granted to hard-wired notions of the enterprise administrator, the machine administrator, and the interactive user.

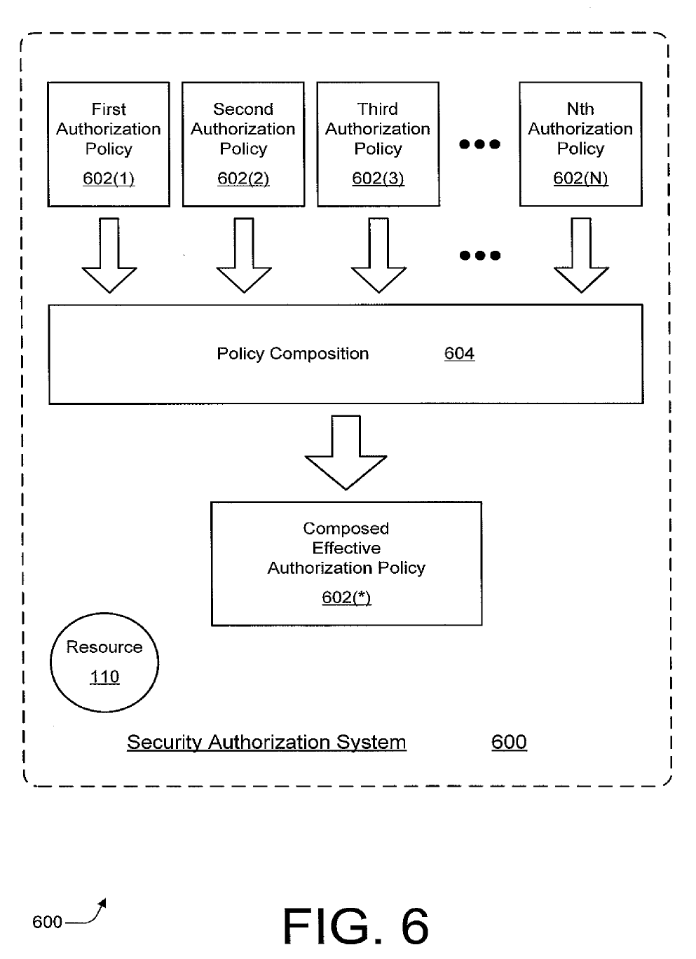

FIG. 6 is a block diagram illustrating an example security authorization system 600 in which multiple authorization policies 602 may be combined into a composed effective authorization policy 602(*). As illustrated, security authorization system 600 includes authorization policies 602, a policy composition unit 604, composed effective authorization policy 602(*) and a resource 110.

More specifically, security authorization system 600 includes “N” authorization policies 602 in which “N” is a positive integer. The integer “N” is also greater than one any time multiple authorization policies 602 are being combined by policy composition unit 604. As explicitly shown, security authorization system 600 includes first authorization policy 602(1), second authorization policy 602(2), third authorization policy 602(3), . . . , Nth authorization policy 602(N).

In a described implementation, each authorization policy 602 is associated with a resource 110. Policy composition unit 604 combines those authorization policies 602 that are input thereto into composed effective authorization policy 602(*). Security authorization system 600 implements a security language (not separately shown) that ensures that authorization policies 602 may be combined in a manner such that any authorization decision based on the combination is predictable. For example, the asserted rights lack negations and are therefore positive and monotonic. Consequently, such assertions compose in an additive manner.

With reference to FIGS. 2 and 3, authorization policies 602 may be located at trust and authorization policy 222, audit policy 226, and/or a security token 204, and so forth. By way of example only, policy composition unit 604 may be realized as part of security policy 220, authorization context 212, and/or authorization engine 218, and so forth. Security authorization system 600 may also include an application programming interface (API) that accepts any of the assertions described herein as input or provides any of them as output.

Certain implementations as described herein address either or both of the following: First, approaches to supporting the separation of duties between administrators based on explicitly assigned policy authoring rights are described. Second, logic-based policy language characteristics that enable independently authored policy components to be unambiguously combined are described.

In a described implementation, there is a general purpose approach to managing the distributed authoring of security policy. The approach can provide fine-grained control over who may author specific types of policies. It also defines how those policies can be logically composed to create the effective policy. Furthermore, the approach can achieve these using the same policy approach and semantics as the authored security policies.

One described aspect is the ability to delegate the rights to author specific types of policy statements to other administrators. This provides flexible and effective controls for defining peer relationships (e.g., allowing another administrator to author the same policies) as well as hierarchical relationships (e.g., one administrator can author a constrained subset of policies).

Administrators and principals can both conceptually be considered as being entities. Nevertheless, they are used herein at times to differentiate between different entities by way of different terminology.

As described herein above, a general form of expression for a described security language implementation comports with the following:
assertor says fact if fact₁, fact₂, . . . , factₙ, constraints_{1 . . . m} .

This same formulation can be used for policy expressions for policy control. This can facilitate the avoidance of potential ambiguity that may arise when semantic translation is required between policies and other types of expressions. A first example below reflects approaches to supporting the separation of duties between administrators based on explicitly assigned policy authoring rights. A second example below reflects logic-based policy language characteristics that enable independently authored policy components to be unambiguously combined.

For the first example, if a principal A is allowed to write authorization policy statements for files in //mycomputer/public, then A can write policies of the form:
A says x read|write|delete //mycomputer/public if x possess (group name, MyDept)
   to allow members of MyDept to access those files. To allow B, a peer, to author such a policy, A can assert the following:
A says B can assert x read|write|delete //mycomputer/public.
   In the assertion above, the delegation-directive verb or predicate is realized with a “can assert” diction. Other diction options for a delegation-directive verbs include, but are not limited to, “can say”, “can profess”, “may assert”, some combination thereof, and so forth.

Conversely, if A wants to only allow B to write access policies governing read access for application Foo's files that are located in //mycomputer/public/Foo, B can assert the following:
A says B can assert x read //mycomputer/public/Foo.
   With the assertion above, a constrained, hierarchical policy authoring relationship between A and B is created. This can also be generally applied to other types of policies that are expressible using the assertion forms, syntax, etc. that is described herein for an example security language.

The second example is directed to a mechanism by which policies authored by multiple authorities can be composed. This is a natural consequence of the logic-based nature of example security language implementations as described herein. It is known that A has authored the following two policy assertions:
A says x read|write|delete //mycomputer/public if x possesses (group name, MyDept); and
A says B can assert x read //mycomputer/public/Foo.
   It is also known that B has authored the following policy assertion:
B says x read H/mycomputer/public/Foo if x possesses (group name, ProjectFoo).

It is given that there are two authenticated input assertions for a request to access //mycomputer/public/Foo/data.txt. The two authenticated input assertions are assumed to be asserted by A for simplicity in this example. The two authenticated input assertions are as follows:
A says C possesses (group name, MyDept); and
A says C possesses (group name, ProjectFoo).

It can then be concluded that C has read, write, and delete access to the file because the two authenticated input assertions satisfy both A's and B's authorization policies. On the other hand, if the only input assertion were the second one (i.e., “A says C possesses (group Name, ProjectFoo)”), then it would be concluded that B has read access to the file but not write or delete.

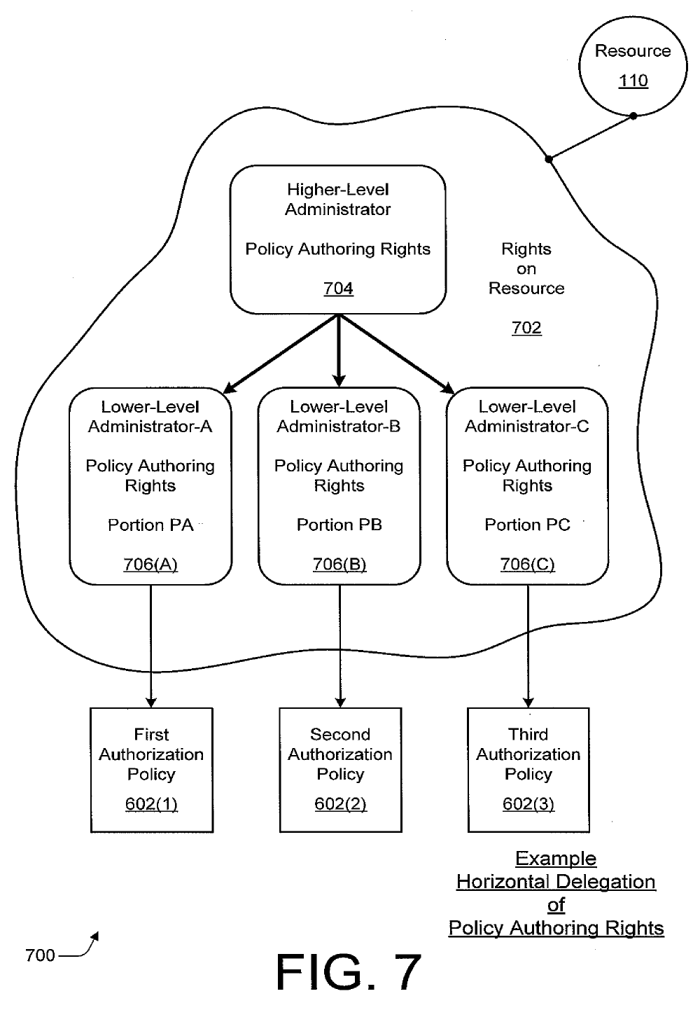

FIG. 7 is a block diagram 700 illustrating an example of horizontal delegation of policy authoring rights. As illustrated, block diagram 700 includes resource 110, rights on resource 702, policy authoring rights 704 and 706, and authorization policies 602. Policy authoring rights 704 belong to or are associated with a higher-level administrator. Policy authoring rights 706(A), 706(B), and 706(C) belong to or are associated with a lower-level administrators A, B, and C, respectively.

In a described implementation, there is a universe of rights 702 with respect to resource 110. The higher-level administrator has at least some, if not all, rights 704 to author policies with respect to resource 110. These policy authoring rights 704 includes at least three portions: PA, PB, and PC. Although three portions are shown, policy authoring rights may be divided into any arbitrary number of portions.

In this example, the higher-level administrator delegates some of its policy authoring rights 704 to the three lower-level administrators. Specifically, lower-level administrator A is delegated policy authoring rights on portion PA 706(A), lower-level administrator B is delegated policy authoring rights on portion PB 706(B), and lower-level administrator C is delegated policy authoring rights on portion PC 706(C).

In turn, each respective lower-level administrator may issue any number of authorization policies 602 within its respective delegated portion 706 of policy authoring rights 704. In the illustrated example, each lower-level administrator has made one authorization policy 602 apiece. Specifically, lower-level administrator A issues first authorization policy 602(1) covering all or part of policy authoring rights portion PA 706(A). Similarly, lower-level administrator B issues second authorization policy 602(2) covering all or part of policy authoring rights portion PB 706(B). And lower-level administrator C issues third authorization policy 602(3) covering all or part of policy authoring rights portion PC 706(C).

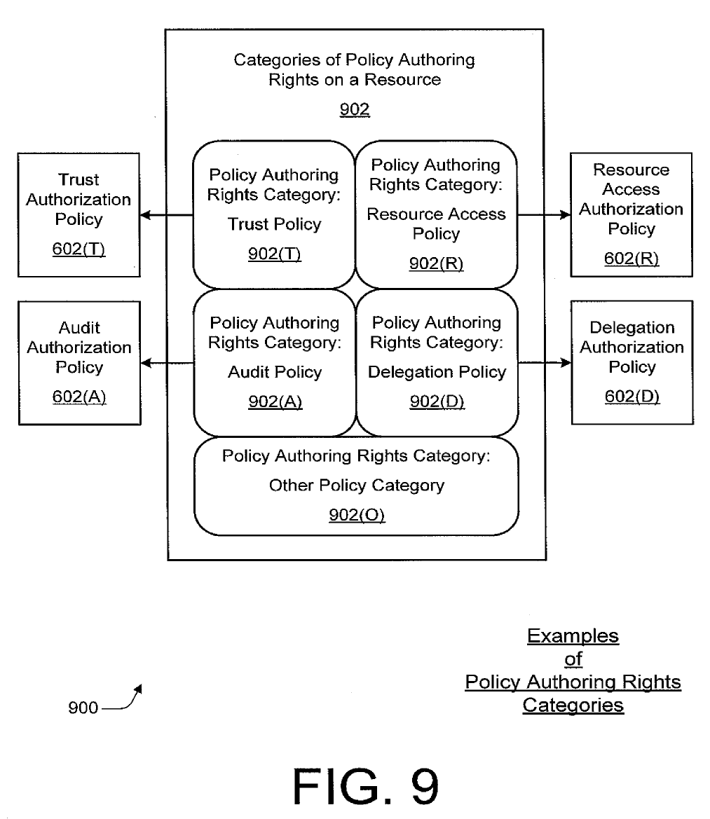

Policy authoring rights 704 of rights on resource 702 may be separated into any number of portions 706. The portions 706 may pertain to any aspect of resource 110. Examples include, but are not limited to, the following. Portions 706 may be directed to different parts of a resource, such as different parts of an overall database. Portions 706 may be directed to different actions or operations that may be performed on a resource. Portions 706 may be directed to different types of principals or groups thereof that may access a resource. Portions 706 may be directed to different policy authoring rights categories. Example policy authoring categories are described herein below with particular reference to FIG. 9.

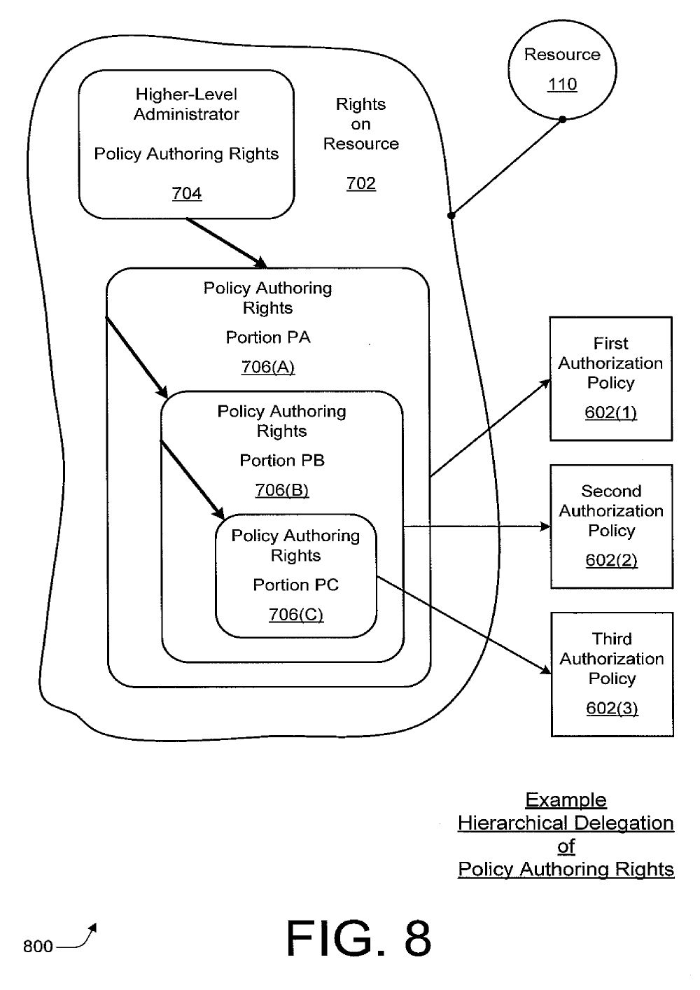

FIG. 8 is a block diagram 800 illustrating an example of hierarchical delegation of policy authoring rights. As illustrated, block diagram 800 includes resource 110, rights on resource 702, policy authoring rights 704, policy authoring rights 706, and authorization policies 602. Although not explicitly shown in FIG. 8 for the sake of clarity, each of the policy authoring portions 706(A), 706(B), and 706(C) is associated with a respective lower-level administrator or principal A, B, and C.

In a described implementation, the higher-level administrator having policy authoring rights 704 delegates all or a part thereof to lower-level administrator A. This delegation grants lower-level administrator A policy authoring rights on portion PA 706(A). Such a policy authoring right assertion may comport generally with a form such as:
H-L Admin says L-L Admin A can assert “authorization policies regarding resource-110 pertaining to portion PA”

In an example, these authorization policies of portion PA include some delegation rights. Lower-level administrator A therefore delegates policy authoring rights portion PB 706(B) to lower-level administrator B. Portion PB likewise includes some delegation rights. Lower-level administrator B therefore delegates policy authoring rights portion PC 706(C) to lower-level administrator C.

Each administrator is therefore able to delegate all or a part of its policy authoring rights when those policy authoring rights include some measure of delegation rights. As shown in block diagram 800, lower-level administrators A, B, and C each issue one respective authorization policy 602(1), 602(2), or 602(3) that is supported by their respective portion 706(A), 706(B), or 706(C) of the policy authoring rights.

As described herein, the variable options for an implementation of the security language enables the different portions and lower-level administrators to be arbitrarily defined. Moreover, the policies are flexible in that they may be changed or adjusted at any time without being bound to some hard-wired approach.

A more specific general format for assertions that enable separation of policy-setting duties and subsequent composition thereof may comport with the following:
assertor says delegation-fact if fact₁, fact₂, . . . , factₙ, constraints_{1 . . . m}, p
   in which delegation-fact delegates a policy authoring right and comports with:
principal delegation-directive-verb delegated-fact,
   in which the delegated-fact includes at least one variable for an expression, a predicate, and/or a resource.

FIG. 9 is a block diagram 900 illustrating example categories 902 of policy authoring rights on a resource. A set of policy authoring rights categories on a resource includes a number of example policy authoring rights categories. Example policy authoring rights categories include, but are not limited to, a trust policy authoring rights category 902(T), a resource access policy authoring rights category 902(R), a delegation policy authoring rights category 902(D), an audit policy authoring rights category 902(A), an other category policy authoring rights category 902(O), and so forth. Although only four different categories are explicitly shown, different and/or additional categories may alternatively be implemented or defined.

Each of these policy authoring rights categories 902 has a corresponding authorization policy 602. Thus, an entity having policy authoring rights in trust category 902(T) may issue a trust authorization policy 602(T). An entity having policy authoring rights in resource access category 902(R) may issue a resource access authorization policy 602(R). An entity having policy authoring rights in delegation category 902(D) may issue a delegation authorization policy 902(D). An entity having policy authoring rights in audit policy 902(A) may issue an audit authorization policy 602(A).

The following descriptions of categories of policy authoring rights are presented by way of example but not limitation. Trust policies usually relate to policies addressing external authorities. Resource access policies usually relate to policies delineating who can access which resource in what manner. Delegation policies usually relate to an ability to grant another a capability to make an assertion. These capabilities may involve an ability to issue authorization policies as described herein. Audit policies usually relate to specifications of what information about a resource authorization decision is to be retained and in what form.

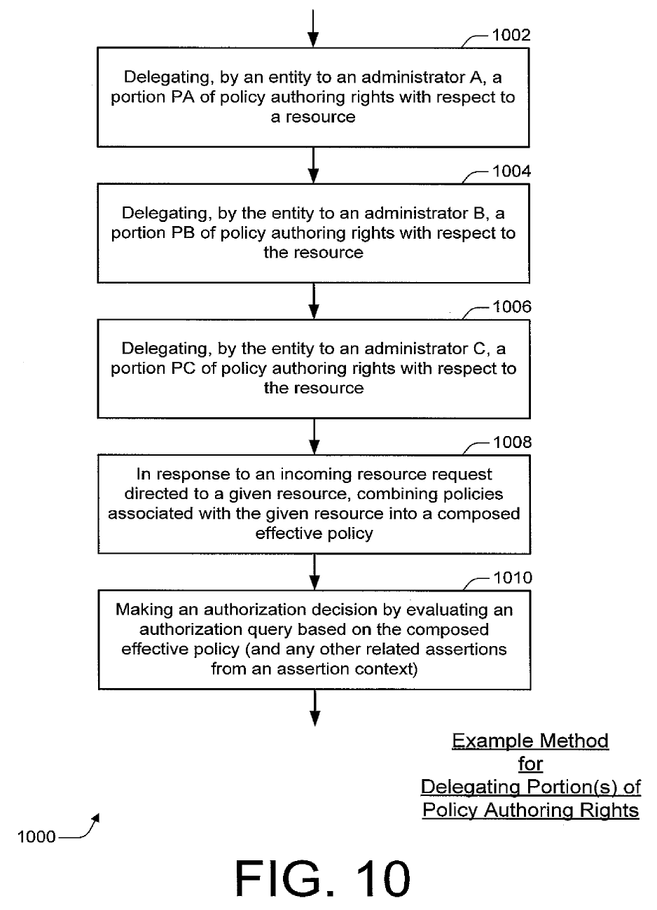

FIG. 10 is a flow diagram illustrating an example of a method for delegating portions of policy authoring rights. Flow diagram 1000 includes five (5) blocks 1002-1010. Although the actions of flow diagram 1000 may be performed in other environments and with a variety of hardware/software/firmware combinations, some of the features, components, and aspects of FIGS. 1-9 are used to illustrate an example of the method.

In a described implementation, at block 1002, a portion PA of policy authoring rights with respect to a resource is delegated by an entity to an administrator A. At block 1004, a portion PB of the policy authoring rights with respect to the resource is delegated by the entity to an administrator B.

At block 1006, a portion PC of the policy authoring rights with respect to the resource is delegated by the entity to an administrator C. Each action of delegating may be effected, for example, using at least one assertion issued by the entity in accordance with a security language as described herein. The assertion may include a delegation-directive verb and a delegation fact, with the delegation fact including one or more variables.

At block 1008, in response to an incoming resource request that is directed to a given resource, the policies associated with the given resource are combined into a composed effective policy. For example, one or more policies may be issued by each of administrators A, B, and C by virtue of their having been delegated policy authoring rights. These separate authorization policies 602 may be combined by a policy composition unit 604 into a composed effective authorization policy 602(*).

At block 1010, an authorization decision is made by evaluating an authorization query based on the composed effective policy (and any other related assertions from an assertion context).

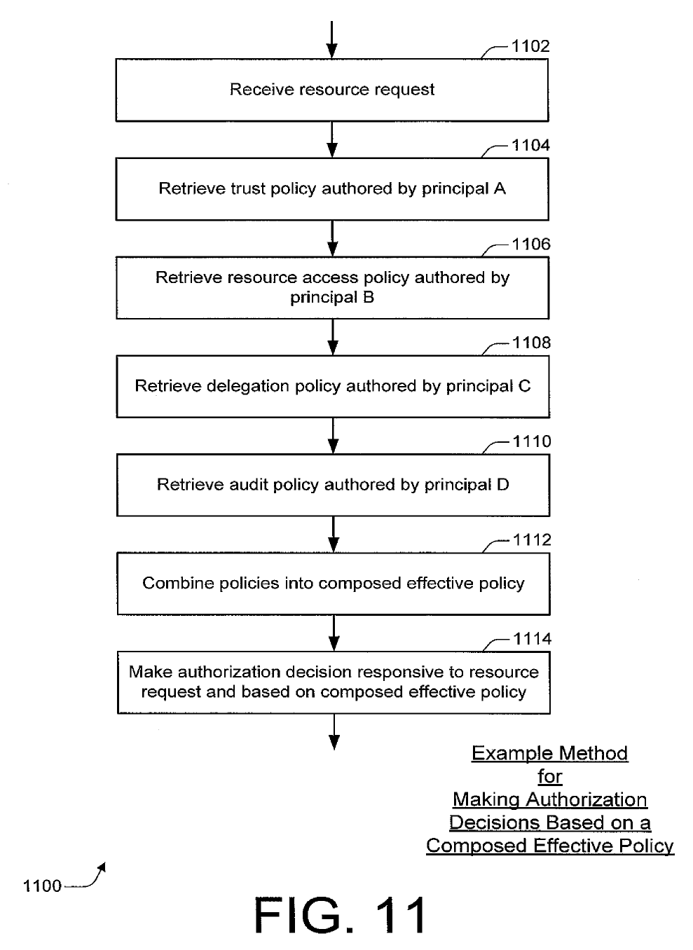

FIG. 11 is a flow diagram illustrating an example of a method for making authorization decisions based on a composed effective policy. Flow diagram 1100 includes seven (7) blocks 1102-1114. Although the actions of flow diagram 1100 may be performed in other environments and with a variety of hardware/software/firmware combinations, some of the features, components, and aspects of FIGS. 1-10 are used to illustrate an example of the method.

In a described implementation, at block 1102, a resource request is received. For example, a resource request directed to a resource 110 may be received. At block 1104, a trust policy authored by a principal A is retrieved. For example, a trust authorization policy 602(1)/602(T) that is associated with a resource 110 and that was authored by an administrator A may be retrieved.

At block 1106, a resource access policy authored by a principal B is retrieved. For example, a resource access authorization policy 602(2)/602(R) that is associated with resource 110 and that was authored by an administrator B may be retrieved.

At block 1108, a delegation policy authored by a principal C is retrieved. For example, a delegation authorization policy 602(3)/602(D) that is associated with resource 110 and that was authored by an administrator C may be retrieved.

At block 1110, an audit policy authored by a principal D is retrieved. For example, an audit authorization policy 602(4)/602(A) that is associated with resource 110 and that was authored by an administrator D may be retrieved.

At block 1112, the different authorization polices from the different policy authoring rights categories may be combined into a composed effective policy. These four different authorization policies may alternatively be from a single category, or there may be two different authorization policies from two different categories. Other permutations are also possible.

Furthermore, the number of authorization policies 602 may be more or less than four. In other words, “N” authorization policies 602(1 . . . N) may be combined in policy composition unit 604 to create composed effective authorization policy 602(*).

At block 1114, an authorization decision is made responsive to the resource request and based on the composed effective policy. For example, an authorization decision may be made by authorization engine 218 responsive to the resource request and based on composed effective authorization policy 602(*).

The devices, actions, aspects, features, functions, procedures, modules, data structures, protocols, components, etc. of FIGS. 1-11 are illustrated in diagrams that are divided into multiple blocks. However, the order, interconnections, interrelationships, layout, etc. in which FIGS. 1-11 are described and/or shown are not intended to be construed as a limitation, and any number of the blocks can be modified, combined, rearranged, augmented, omitted, etc. in any manner to implement one or more systems, methods, devices, procedures, media, apparatuses, APIs, protocols, arrangements, etc. for composable security policies.

Although systems, media, devices, methods, procedures, apparatuses, mechanisms, schemes, approaches, processes, arrangements, and other implementations have been described in language specific to structural, logical, algorithmic, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. A method comprising:
receiving a resource request that is directed to a resource;
retrieving a trust policy that is authored by principal A, the trust policy associated with the resource;
retrieving a resource access policy that is authored by principal B, the resource authorization policy associated with the resource;
combining the trust policy and the resource access policy into a composed effective policy; and
making an authorization decision responsive to the resource request and based on the composed effective policy.

2. The method as recited in claim 1, further comprising:
retrieving a delegation policy that is authored by principal C, the delegation policy associated with the resource;
wherein the combining comprises:
combining the delegation policy into the composed effective policy.

3. The method as recited in claim 1, further comprising:
retrieving an audit policy that is authored by principal D, the audit policy associated with the resource;
wherein the combining comprises:
combining the audit policy into the composed effective policy.

4. The method as recited in claim 1, further comprising:
delegating, by an administrator, a right to author the trust policy to the principal A; and
delegating, by the administrator, a right to author the resource access policy to the principal B.

5. The method as recited in claim 1, further comprising:
delegating, by a first administrator, a right to author the trust policy to the principal A; and
delegating, by a second administrator, a right to author the resource access policy to the principal B.

6. The method as recited in claim 1, wherein the trust policy identifies a security token service (STS) that is empowered to assert that principals possesses one or more attributes; and wherein the resource access policy specifies at least one attribute that a principal must possess to access the resource.

7. The method as recited in claim 1, wherein the trust policy is authored by the principal A using a security language, and the resource access policy is also authored by the principal B using the security language; and wherein the combining is enabled by the security language.

8. A method comprising:
delegating, by an entity to an administrator A, a portion PA of policy authoring rights with respect to a resource; and
delegating, by the entity to an administrator B, a portion PB of the policy authoring rights with respect to the resource;
wherein each delegating is effected using at least one assertion issued by the entity in accordance with a security language, the at least one assertion including a delegation-directive verb.

9. The method as recited in claim 8, further comprising:
issuing, by the administrator A, a first authorization policy that is directed to the portion PA of the policy authoring rights with respect to the resource; and
issuing, by the administrator B, a second authorization policy that is directed to the portion PB of the policy authoring rights with respect to the resource.

10. The method as recited in claim 8, wherein:
the portions PA and PB relate to different parts of the resource;
the portions PA and PB relate to different actions that may be taken with regard to the resource;
the portions PA and PB relate to different policy categories that may exist with regard to security polices about the resource; or
the portions PA and PB relate to different groups of principals that may access the resource.

11. The method as recited in claim 8, wherein the portion PA relates to actions that may be taken on the resource, and the portion PB relates to identifying types of principals that may access the resource.

12. The method as recited in claim 8, further comprising:
delegating, by the entity to an administrator C, a portion PC of the policy authoring rights with respect to the resource; and
wherein the three delegating actions enable the entity to separate duties with respect to the resource among the three different administrators A, B, and C.

13. The method as recited in claim 8, wherein the portion PA of the policy authoring rights comprises delegation rights with respect to the resource; and
wherein the method further comprises:
delegating, by the administrator A to a sub-administrator, a particular part of the portion PA of the policy authoring rights with respect to the resource.

14. The method as recited in claim 13, farther comprising:
issuing, by the sub-administrator, a policy directed to the particular part of the portion PA of the policy authoring rights with respect to the resource;
receiving a resource request that is directed to the resource;
combining policy assertions from the entity, the administrator A, and the sub-administrator into a composed effective policy; and
making an authorization decision responsive to the resource request and based on the composed effective policy.

15. A security authorization system comprising policy authoring rights on at least one resource and a security language; wherein the security language includes a mechanism enabling an administrator to explicitly grant all or a part of the policy authoring rights to another administrator so as to allow the other administrator to make policy assertions about the at least one resource; and wherein the mechanism comprises a delegation-directive verb.

16. The security authorization system as recited in claim 15, wherein each policy assertion includes at least one variable representing a principal, at least one variable representing a resource, or at least one variable representing an action on a resource.

17. The security authorization system as recited in claim 15, further comprising an application programming interface (API) that accepts the policy assertions.

18. The security authorization system as recited in claim 15, wherein the mechanism comprises an assertion that comports with the following:
assertor says delegation-fact if fact₁, fact₂, . . . , factₙ, constraints_{1 . . . m}, in which (i) fact_{1 . . . n} and constraints_{1 . . . m} are optional in each assertion and (ii) the “delegation fact” delegates at least one policy authoring right and comports with:
principal delegation-directive-verb delegated-fact.

19. The security authorization system as recited in claim 15, wherein each policy assertion is monotonic such that each assertion adds one or more rights.

20. The security authorization system as recited in claim 15, further comprising a policy composition mechanism that combines multiple authorization policies that are associated with a given resource into a composed effective authorization policy that may be used in an authorization decision regarding the given resource.
